(19) United States
(12) Patent Application Publication
(10) Pub. No.: US 2024/0247156 A1
(43) Pub. Date: Jul. 25, 2024

(54) Conductive Material Composition, Conductive Film, And Method For Forming Conductive Film

(71) Applicant: SHIN-ETSU CHEMICAL CO., LTD., Tokyo (JP)

(72) Inventors: Jun HATAKEYAMA, Joetsu-shi (JP); Shiori NONAKA, Joetsu-shi (JP); Daisuke KORI, Joestsu-shi (JP)

(73) Assignee: SHIN-ETSU CHEMICAL CO., LTD., Tokyo (JP)

(21) Appl. No.: 18/404,813

(22) Filed: Jan. 4, 2024

(30) Foreign Application Priority Data
Jan. 18, 2023 (JP) 2023-005811

(51) Int. Cl. C09D 5/24; B22F 1/054; B22F 1/10; C09D 7/40; C09D 7/61; C09D 159/00; C23C 24/10

(52) U.S. Cl. CPC C09D 5/24; B22F 1/0547; B22F 1/10; C09D 7/61; C09D 7/70; C09D 159/00; C23C 24/106; B22F 2301/255; H01B 1/02

(57) ABSTRACT

The present invention is a conductive material composition containing: (A) metal nanowires; (B) a resin whose main chain is to be decomposed by an acid, heat, or both; and (C) a solvent. This can provide a conductive material composition for forming a conductive film having high-conductivity and high-transparency.

### TECHNICAL FIELD

The present invention relates to: a conductive material composition for forming a conductive film having high transparency and high conductivity; a conductive film; and a method for forming the same.

### BACKGROUND ART

In recent years, market expansion of highly transparent conductive films continues, accompanying the spread of organic EL displays and touch panels.

As transparent electrodes, indium tin oxide (ITO) films are widely used (Patent Document 1).

For non-contact touch panels, transparent electrodes having higher conductivity than ITO are necessary, and for this purpose, silver nanowires are a candidate (Patent Document 2).

Silver nanowires were initially manufactured by a template method. As a template, carbon nanotube, porous silica, alumina, surfactant, and block copolymer were used, but reaction time was long, and there was a problem that the productivity of silver nanowires was low.

There is a proposal for a method of allowing nanowires to grow through the reduction of silver nitrate or the like by adding a surfactant, such as polyvinylpyrrolidone, in water or ethylene glycol (Non Patent Document 1). This method has high productivity, and has made the mass production of silver nanowires possible.

Heating a substrate coated with silver nanowires at about 250° C. allows the silver nanowires to melt and be fused together, and thus, the degradation of conductivity can be suppressed even when the substrate expands or contracts (Non Patent Document 2). A flash annealing method, according to which silver nanowires alone can be heated by irradiation with light for a very short time, can suppress a rise in the temperature of a substrate and makes it possible to fuse together silver nanowires on a polyurethane film, which has elasticity but only has heat resistance to temperatures lower than 250° C. (Non Patent Document 3). In addition, Non Patent Document 4 discloses the self-assembly of silver nanowires.

When a silver nanowire ink consisting of only solvent and silver nanowires is applied, the distribution of the silver nanowires becomes uneven in some cases. If the distribution of the silver nanowires is uneven, spots form in transparency or conductivity, and there is risk of the performance of a device using the ink being degraded.

Furthermore, during heating for fusing the silver nanowires with each other after applying a silver nanowire ink consisting only of solvent and silver nanowires, the silver nanowires break before fusion in some instances. Particularly when the density of the silver nanowires is low or when the diameter of the silver nanowires is small, there is no support through contact of the wires with each other and the strength of the wires themselves is insufficient. For this reason, it seems that the wires break due to aerial vibration in a high temperature. In order to form highly transparent conductive films, the concentration of silver nanowires is reduced or silver nanowires having a small diameter are used, and it is necessary to fuse the silver nanowires without breaking the silver nanowires.

For applying silver nanowires uniformly or for preventing silver nanowires from breaking during heating, there is a method of adding a resin as a component of a silver nano-ink. For example, Non Patent Document 5 discloses technology regarding the synthesis of silver nanostructures in the presence of polyvinylpyrrolidone. Due to a resin being contained, the applied film is planarized, and the resin supports the silver nanowires and can prevent the silver nanowires from breaking. However, adding a resin having insulating property leads to the degradation of conductivity. Accordingly, there are demands for the development of an ink for forming a uniform, high-conductivity silver nanowire layer.

### CITATION LIST

### Patent Literature

Patent Document 1: JPS41-10504B
Patent Document 2: JP2022-135862A

### Non Patent Literature

Non Patent Document 1: Yugang Sun et al. “Crystalline Silver Nanowires by Soft Solution Processing”, Nano letters, Vol. 2, (2002), No. 2, p. 165-168
Non Patent Document 2: Natsuki Komoda et al. “Electrical conductivity of silver nanowire printed line”, The 26th Japan Institute of Electronics Packaging Spring Meeting, Meeting Proceedings, 9D-04, (2012), p. 318
Non Patent Document 3: Yang Yang et al. “Facile fabrication of stretchable Ag nanowire/polyurethane electrodes using high intensity pulsed light”, Nano Research, 9 (2), (2016), p. 401-414
Non Patent Document 4: Y. Gao et al. “Synthesis, characterization and self-assembly of silver nanowires”, Chemical Physics Letters, 380, (2003), p. 146-149
Non Patent Document 5: Masaharu Tsuji et al. “Effects of chain length of polyvinylpyrrolidone for the synthesis of silver nanostructures by a microwave-polyol method”, Materials Letters, 60, (2006), p. 834-838

### SUMMARY OF INVENTION

### Technical Problem

The present invention has been made to solve the above-described problems, and an object thereof is to provide: a conductive material composition for forming a conductive film having high-conductivity and high-transparency; a conductive film having a high-conductivity and high-transparency; and a method for forming a conductive film having high conductivity and high transparency.

### Solution to Problem

To achieve the object, the present invention provides a conductive material composition comprising:
(A) metal nanowires;
(B) a resin whose main chain is to be decomposed by an acid, heat, or both; and
(C) a solvent.

Such a conductive material composition makes it possible to manufacture a conductive film that is uniform, has high transparency, and has high conductivity, at low cost.

The resin (B) preferably comprises a repeating unit having an acetal structure represented by the following general formula (1),

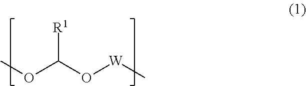

wherein R¹ represents a hydrogen atom or a saturated or unsaturated monovalent organic group having 1 to 30 carbon atoms, the organic group being optionally substituted; and W represents a saturated or unsaturated divalent organic group having 2 to 30 carbon atoms.

Such a conductive material composition can exhibit appropriate decomposability and flowability.

The resin (B) is particularly preferably a compound represented by one of the following general formulae (1a) to (1c),

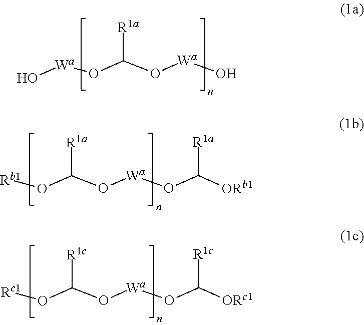

wherein R^{1a} represents an alkyl group having 1 to 4 carbon atoms; W^{a} represents a saturated or unsaturated divalent hydrocarbon group having 4 to 10 carbon atoms and optionally has an ether bond; each R^{b1} independently represents —W^{a}—OH or a saturated or unsaturated monovalent organic group having 1 to 30 carbon atoms, the organic group being optionally substituted; R^{1c} represents a hydrogen atom, an aryl group having 6 to 20 carbon atoms, or a heteroaryl group having 4 to 20 carbon atoms, the aryl group or the heteroaryl group being optionally substituted; each R^{c1} independently represents an alkyl group having 1 to 4 carbon atoms or —W^{a}—OH; and “n” represents an average repeating unit number of 3 to 2,000.

Such a conductive material composition can exhibit even more appropriate decomposability and flowability.

The composition may further comprise a photo-acid generator or a thermal acid generator.

When a photo-acid generator or a thermal acid generator is contained, the decomposition temperature of the resin (B) can be lowered.

The present invention also provides a conductive film formed on a substrate, comprising
a coating of the inventive conductive material composition on the substrate, wherein the resin (B) component has been decomposed and/or removed by an acid, heat, or both.

Such a conductive film can achieve high transparency and high conductivity.

The present invention also provides a method for forming a conductive film, comprising:
coating a substrate with the inventive conductive material composition; and
decomposing and/or removing the resin (B) component by an acid, heat, or both to form a conductive film.

According to such a method for forming a conductive film, it is possible to manufacture a film that is uniform and has high transparency and high conductivity, at low cost.

### Advantageous Effects of Invention

As described above, the inventive conductive material composition makes it possible to manufacture a conductive film that is uniform, highly transparent, and highly conductive, at low cost.

Meanwhile, the inventive conductive film is a highly transparent and highly conductive film.

In addition, according to the inventive method for forming a conductive film, a uniform, highly transparent, and highly conductive film can be manufactured at low cost.

### BRIEF DESCRIPTION OF DRAWINGS

FIG. 1 is a cross-sectional view of a coating film obtained by applying an example of the inventive conductive material composition onto a substrate.

FIG. 2 is a cross-sectional view of a conductive film obtained by decomposing and removing a resin in the coating film shown in FIG. 1 by an acid, heat, or both.

FIG. 3 shows thermal decomposition data (DTA) of a resin B1 used in Examples 1 to 3 in air.

FIG. 4 is a scanning electron microscope (SEM) photograph, observed at a magnification of 10,000×, of a surface of a film obtained by applying a conductive material composition of Example 1 onto a quartz wafer and baking the composition on a hot plate at 220° ° C. for 10 minutes.

FIG. 5 is a scanning electron microscope (SEM) photograph, observed at a magnification of 10,000×, of a surface of a film obtained by applying the conductive material composition of Example 1 onto a quartz wafer and baking the composition on a hot plate at 250° ° C. for 10 minutes.

FIG. 6 is a scanning electron microscope (SEM) photograph, observed at a magnification of 10,000×, of a surface of a film obtained by applying a conductive material composition of Comparative Example 1 onto a quartz wafer and baking the composition on a hot plate at 250° ° C. for 10 minutes.

FIG. 7 is a scanning electron microscope (SEM) photograph, observed at a magnification of 10,000×, of a surface of a film obtained by applying a conductive material composition of Comparative Example 2 onto a quartz wafer and baking the composition on a hot plate at 250° ° C. for 10 minutes.

### DESCRIPTION OF EMBODIMENTS

As stated above, there have been demands for the development of a thin conductive film that is uniform, highly transparent, and highly conductive.

The present inventors have earnestly studied the above matters and found out that a conductive material composition containing metal nanowires, a resin whose main chain is to be decomposed by an acid, heat, or both, and a solvent makes it possible to form a uniform layer of metal nanowires by virtue of the presence of the resin during the application of the conductive material composition, and by the insulating resin being decomposed and evaporating due to an acid and/or heat, it is possible to form a high-transparency and high-conductivity metal nanowire layer (conductive film). Based on the findings, the present invention has been completed.

That is, the present invention is a conductive material composition comprising:
(A) metal nanowires;
(B) a resin whose main chain is to be decomposed by an acid, heat, or both; and
(C) a solvent.

In addition, the present invention is a conductive film formed on a substrate, comprising
a coating of the inventive conductive material composition on the substrate, wherein the resin (B) component has been decomposed and/or removed by an acid, heat, or both.

In addition, the present invention is a method for forming a conductive film, comprising:
coating a substrate with the inventive conductive material composition; and
decomposing and/or removing the resin (B) component by an acid, heat, or both to form a conductive film.

Hereinafter, the present invention will be described in detail, but the present invention is not limited thereto.

### [Conductive Material Composition]

The inventive conductive material composition contains:
(A) metal nanowires;
(B) a resin whose main chain is to be decomposed by an acid, heat, or both; and
(C) a solvent.

When such a conductive material composition is used, it is possible to form a coating film having a uniform metal nanowire layer by virtue of the presence of the resin (B) during the application of the composition. Furthermore, since the insulating resin (B) can be decomposed and/or removed by an acid and/or heat, the high-resistivity resin (B) can be eliminated from the coating film by virtue of heating the coating film of the composition or by virtue of allowing an acid to be generated in the coating film. Thus, it is possible to obtain a conductive film (metal nanowire layer) containing no resin (B), that is, having high conductivity. The metal nanowires contained in the obtained conductive film have diameters on a nanometer level, and therefore, can transmit visible light. Thus, the obtained conductive film can achieve high transparency.

Moreover, this conductive film is flexible, and therefore, can be applied to flexible touch sensors, displays, and illuminations. Furthermore, the conductive film also has elasticity, and therefore, is also applicable to biosensors such as bio-electrodes to be attached to the body.

Hereinafter, each component of the inventive conductive material composition will be described in more detail.

### [(A) Metal Nanowires]

The component (A) metal nanowires can, for example, have a diameter of 1 to 200 nm, and a length of 0.5 to 500 μm. When preparing the inventive conductive material composition, the metal nanowires (A) are preferably in a form of being dispersed in water or a lower alcohol.

The metal species of the metal nanowires (A) is not particularly limited, but the metal species is preferably silver, and besides this, gold, copper, and cobalt can be used. The metal nanowires (A) may also be an alloy of silver and gold, platinum, copper, cobalt, etc., rather than silver alone.

### [(B) Resin]

The component (B) resin is a resin (decomposable polymer) whose main chain is to be decomposed by an acid, heat, or both.

Preferable embodiments of the resin (B) include resins containing a repeating unit having an acetal structure represented by the following general formula (1).

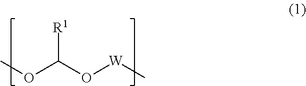

In the formula, R¹ represents a hydrogen atom or a saturated or unsaturated monovalent organic group having 1 to 30 carbon atoms, the organic group being optionally substituted. W represents a saturated or unsaturated divalent organic group having 2 to 30 carbon atoms.

Further preferable embodiments of the component (B) include compounds represented by the following general formulae (1a) to (1c) (hereinafter, also referred to as “decomposable polymers (1a) to (1c)”).

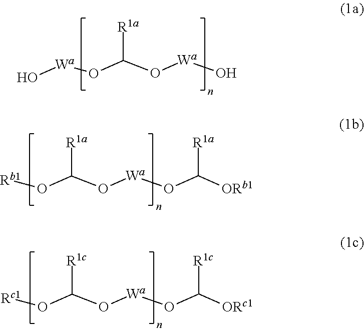

In the general formulae (1a) to (1c), R^{1a} represents an alkyl group having 1 to 4 carbon atoms. W^{a} represents a saturated or unsaturated divalent hydrocarbon group having 4 to 10 carbon atoms and optionally has an ether bond. Each R^{b1} independently represents —W^{a}—OH or a saturated or unsaturated monovalent organic group having 1 to 30 carbon atoms, the organic group being optionally substituted. R^{1c} represents a hydrogen atom, an aryl group having 6 to 20 carbon atoms, or a heteroaryl group having 4 to 20 carbon atoms, the aryl group or the heteroaryl group being optionally substituted. Each R^{c1} independently represents an alkyl group having 1 to 4 carbon atoms or —W^{a}—OH. “n” represents an average repeating unit number of 3 to 2,000, preferably 3 to 500.

The presence of the linear acetal structure represented by the general formula (1) or (1a) to (1c) is effective for providing the resin (B) with suitable decomposability and flowability. Furthermore, after decomposition, the resin is decomposed into a low-molecular-weight compound having high volatility, and therefore, there is little risk of a large amount of the resin remaining in the conductive film and degrading the conductivity of the conductive film.

In the general formula (1), R¹ represents a hydrogen atom or a saturated or unsaturated monovalent organic group having 1 to 30 carbon atoms, the organic group being optionally substituted.

Here, “organic group” in the present invention means a group including at least one carbon atom, can further include a hydrogen atom, and may also include a nitrogen atom, an oxygen atom, a sulfur atom, a silicon atom, a halogen atom, etc.

R¹ may be of one kind, or a plurality of kinds may be present. More specific examples of R¹ include a hydrogen atom, a methyl group, an ethyl group, a vinyl group, a 2,2,2-trifluoroethyl group, a propyl group, an isopropyl group, an allyl group, a 1-propenyl group, an isopropenyl group, a butyl group, an s-butyl group, a t-butyl group, an isobutyl group, a pentyl group, a cyclopentyl group, a hexyl group, a cyclohexyl group, a cyclohexenyl group, a decyl group, a dodecyl group, an icosyl group, a norbornyl group, an adamantyl group, a phenyl group, a toluyl group, a xylyl group, a naphthyl group, a phenanthrenyl group, an anthracenyl group, a benzyl group, a fluorenyl group, a naphthylmethyl group, a norbornenyl group, a triacontyl group, a 2-furanyl group, and a 2-tetrahydrofuranyl group.

In the general formula (1), W represents a saturated or unsaturated divalent organic group having 2 to 30 carbon atoms. W may be of one kind, or a plurality of kinds may be present. More specific examples of W include an ethylene group, a propylene group, a butylene group, a trimethylene group, a tetramethylene group, a pentamethylene group, a hexamethylene group, a heptamethylene group, an octamethylene group, a decamethylene group, a dodecamethylene group, an eicosamethylene group, a triacontamethylene group, a cyclopentanediyl group, a cyclohexanediyl group, a dimethylcyclohexanediyl group, a 2-butene-1,4-diyl group, a 2,4-hexadiene-1,6-diyl group, a 3-oxapentane-1,5-diyl group, a 3,6-dioxaoctane-1,8-diyl group, a 3,6,9-trioxaundecane-1,11-diyl group, a phenylene group, a xylyl group, a naphthalenediyl group, a dimethylnaphthalenediyl group, and an adamantanediyl group.

In the general formulae (1a) and (1b), R^{1a} represents an alkyl group having 1 to 4 carbon atoms. R^{1a} may be of one kind, or a plurality of kinds may be present. More specific examples of Ria include a methyl group, an ethyl group, a propyl group, an isopropyl group, a butyl group, an s-butyl group, a t-butyl group, and an isobutyl group.

In the general formulae (1a) to (1c), W^{a} represents a saturated or unsaturated divalent hydrocarbon group having 4 to 10 carbon atoms and optionally has an ether bond. W^{a} may be of one kind, or a plurality of kinds may be present. More specific examples of W^{a} include a tetramethylene group, a pentamethylene group, a hexamethylene group, a heptamethylene group, an octamethylene group, a decamethylene group, a cyclopentanediyl group, a cyclohexanediyl group, a dimethylcyclohexanediyl group, a 2-butene-1,4-diyl group, a 2,4-hexadiene-1,6-diyl group, a 3-oxapentane-1,5-diyl group, a 3,6-dioxaoctane-1,8-diyl group, a 3,6,9-trioxaundecane-1,11-diyl group, a phenylene group, a xylyl group, and an adamantanediyl group.

In the general formula (1b), each R^{b1} independently represents —W^{a}—OH or a saturated or unsaturated monovalent organic group having 1 to 30 carbon atoms, the organic group being optionally substituted. More specific examples of the saturated or unsaturated monovalent organic group having 1 to 30 carbon atoms and optionally being substituted include a methyl group, an ethyl group, a vinyl group, a 2, 2,2-trifluoroethyl group, a propyl group, an isopropyl group, an allyl group, a 1-propenyl group, an isopropenyl group, a butyl group, an s-butyl group, a t-butyl group, an isobutyl group, a pentyl group, a cyclopentyl group, a hexyl group, a cyclohexyl group, a cyclohexenyl group, a decyl group, a dodecyl group, an icosanyl group, a norbornyl group, an adamantyl group, a phenyl group, a toluyl group, a xylyl group, a naphthyl group, a phenanthrenyl group, an anthracenyl group, a benzyl group, a fluorenyl group, a naphthylmethyl group, a norbornenyl group, a triacontyl group, a 2-furanyl group, and a 2-tetrahydrofuranyl group.

In the general formula (1c), R^{1c} represents a hydrogen atom, an aryl group having 6 to 20 carbon atoms, or a heteroaryl group having 4 to 20 carbon atoms, the aryl group or the heteroaryl group being optionally substituted. R^{1c} may be of one kind, or a plurality of kinds may be present. More specific examples of R^{1c} include a hydrogen atom, a phenyl group, a toluyl group, a xylyl group, a naphthyl group, a phenanthrenyl group, an anthracenyl group, a 2-furanyl group, and an anisyl group.

In the general formula (1c), each R^{c1} independently represents an alkyl group having 1 to 4 carbon atoms or —W^{a}—OH. More specific examples of the alkyl group having 1 to 4 carbon atoms include a methyl group, an ethyl group, a propyl group, an isopropyl group, a butyl group, an s-butyl group, a t-butyl group, and an isobutyl group.

“n” represents an average repeating unit number of 3 to 2000, preferably 3 to 500, more preferably 5 to 300.

When the resin (B) includes a repeating unit having an acetal structure represented by the general formula (1), the resin may have only one kind of the repeating unit, or may have two or more kinds of the repeating unit in combination.

Further specific examples of the repeating unit having an acetal structure represented by the general formula (1) include the following, but are not limited thereto.

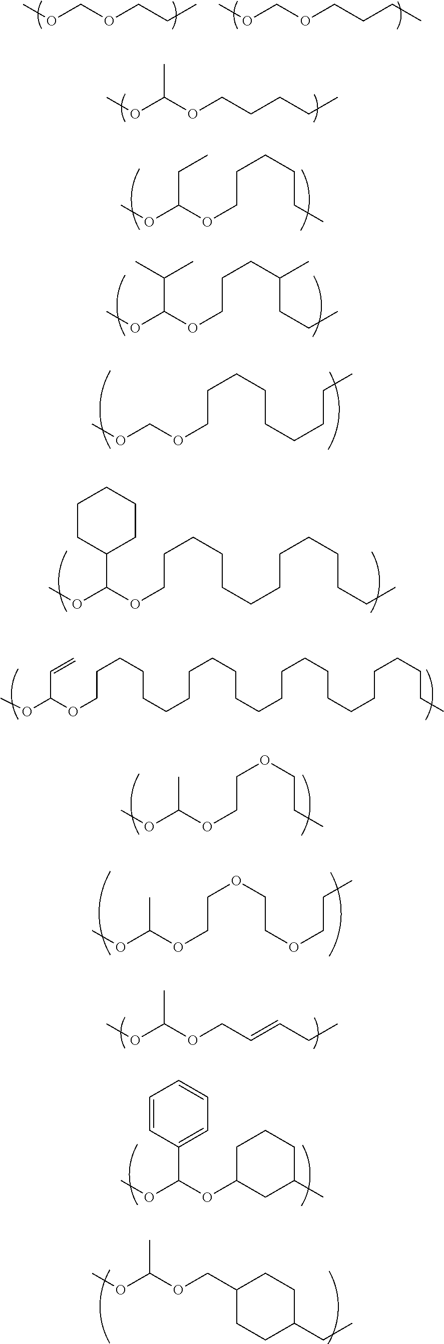

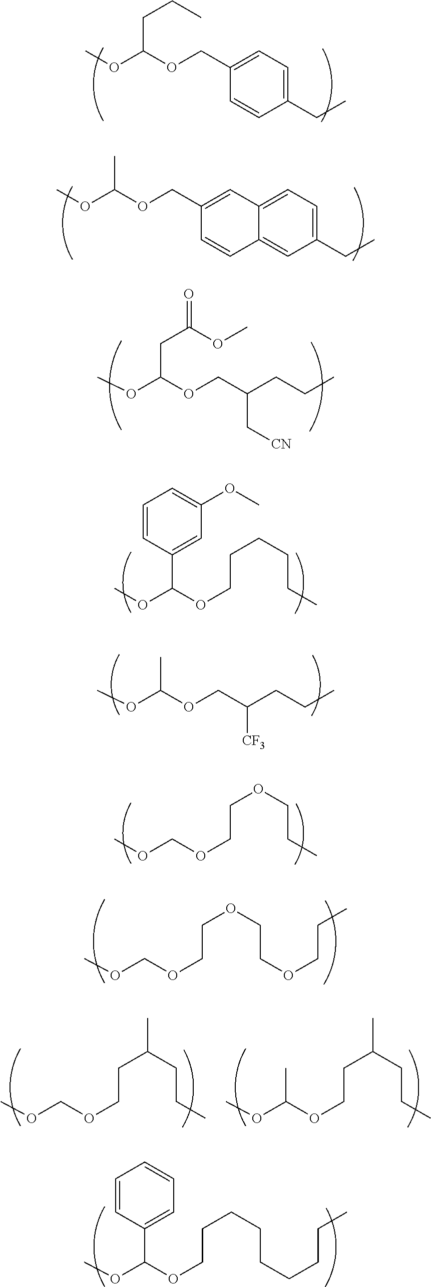

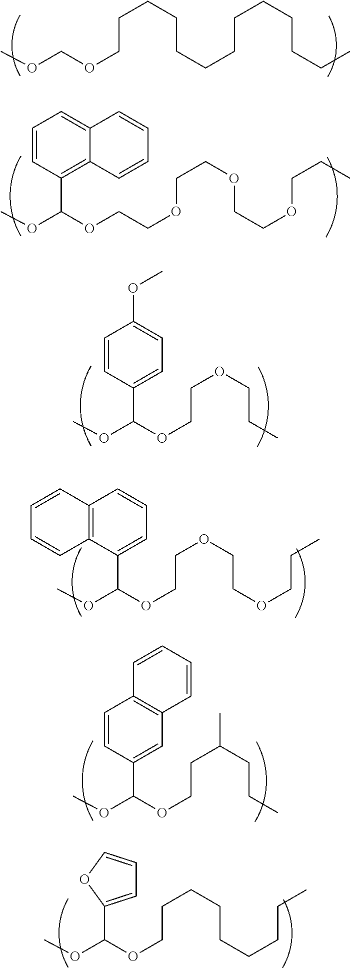

Further specific examples of the compound represented by the general formula (1a) include the following, but are not limited thereto. In the following formulae, “n” is as defined above.

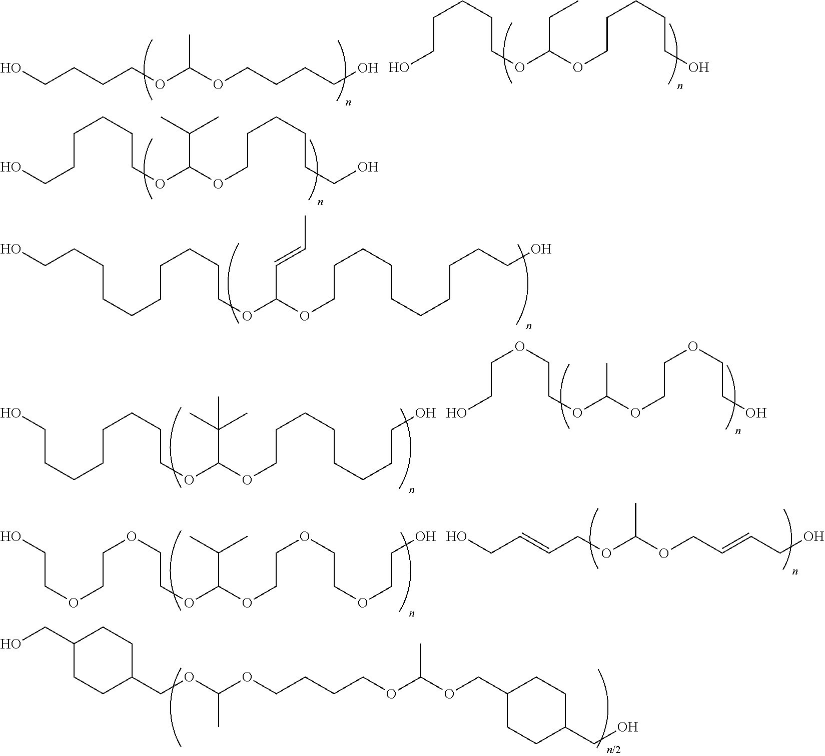

Further specific examples of the compound represented by the general formula (1b) include the following, but are not limited thereto. In the following formulae, “n” is as defined above.

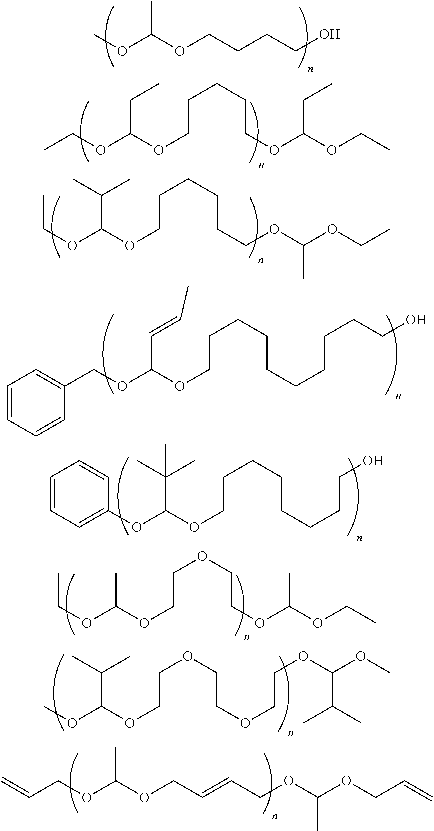

Further specific examples of the compound represented by the general formula (1c) include the following, but are not limited thereto. In the following formulae, “n” is as defined above.

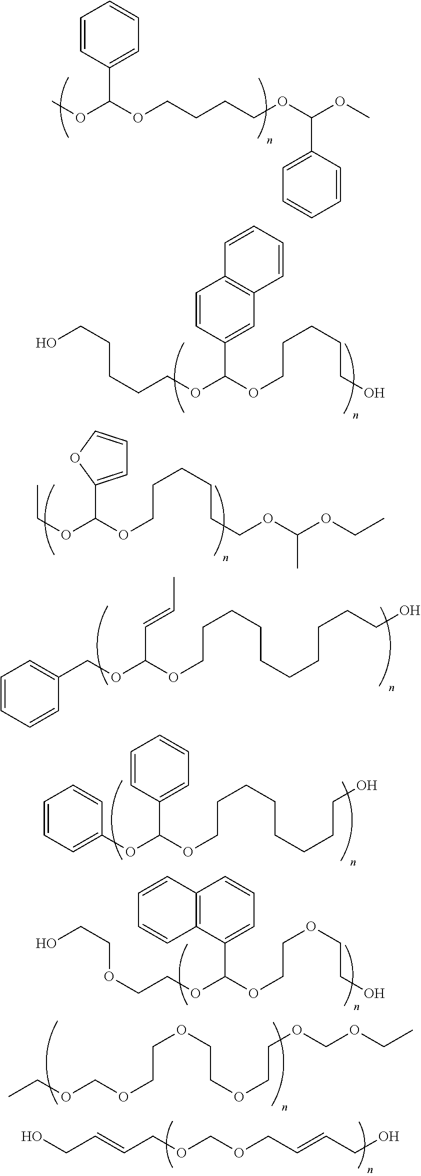

By the choice of the structures of R¹, R^{1a}, R^{b1}, R^{1c}, R^{c1}, W, and W^{a}, the properties of the resin (B), such as thermal decomposition temperature, weight loss rate during heating, and flowability, can be adjusted as necessary, and consequently, the properties of the conductive material composition can be adjusted.

In particular, the decomposable polymers (1a) to (1c) have excellent flowability, and in addition, the weight loss rate during heating can be set easily to 70% by mass or more by the choice of the structures of R^{1a} and W^{a}. The decomposable polymers (1a) and (1b) have a low thermal decomposition temperature, and as a result, can suppress further the degradation of the etching resistance of the conductive film material. Therefore, these polymers are desirable. The thermal decomposable polymer (1c) also functions as a crosslinking agent in some cases, and makes it possible to widen further the adjustment range of the properties of the conductive film material. Therefore, this polymer is desirable.

The resin (B) preferably has a weight-average molecular weight of 300 to 200,000, more preferably 300 to 50,000, and further preferably 500 to 40,000. The average number of repeating units is preferably 3 to 2,000, further preferably 3 to 500. When the weight-average molecular weight is 300 or more, it is possible to suppress the degradation of a blending effect due to volatilization or the like, and a sufficient blending effect can be achieved. Meanwhile, when the weight-average molecular weight is 200,000 or less, there is no risk of the flowability being degraded or the like, and excellent filling and planarizing properties can be achieved.

Regarding the decomposable polymer having a structure represented by the general formula (1) or (1a), the optimum method can be selected in accordance with the structure to manufacture the polymer. To take the decomposable polymer (1a) as an example, specifically, it is possible to select a method from the following three methods, for example, and manufacture the polymer. By a similar method, the decomposable polymer (1) can also be manufactured. It should be noted that methods for manufacturing the decomposable polymer used in the present invention are not restricted to these methods.

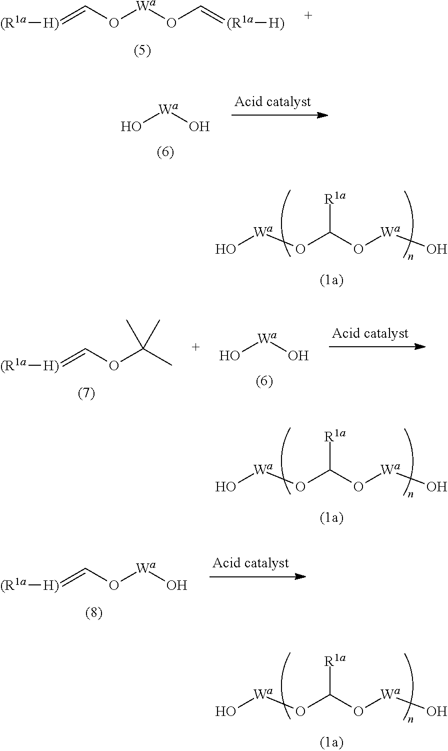

In the formulae, R^{1a} represents an alkyl group having 1 to 4 carbon atoms. W^{a} represents a saturated or unsaturated divalent hydrocarbon group having 4 to 10 carbon atoms and optionally has an ether bond. “n” represents an average repeating unit number of 3 to 2,000.

The elementary reaction in the above reactions is a common acetal formation reaction performed with an acid catalyst. This elementary reaction is repeated and progresses, and thus, a polymer is given in the end. In the above reaction, the optimum amount of the diol compound (6) to be used relative to the amount of the diether compound (5) is preferably 0.5 mol to 2 mol, particularly preferably 0.8 mol to 1.2 mol of (6) relative to 1 mol of (5). In the above reactions, the optimum amount of the diol compound (6) to be used relative to the amount of the t-butyl ether compound (7) is preferably 0.5 mol to 2 mol, particularly preferably 0.8 mol to 1.2 mol of (6) relative to 1 mol of (7).

The acetalization reaction can be performed by mixing raw materials with an acid catalyst in a solvent or without a solvent and cooling or heating. When a solvent is to be used in the reaction, the solvent can be selected from aliphatic hydrocarbons, such as hexane and heptane; aromatic hydrocarbons, such as toluene, xylene, trimethylbenzene, and methylnaphthalene; ethers, such as diethyl ether, dibutyl ether, diethylene glycol diethyl ether, diethylene glycol dimethyl ether, and tetrahydrofuran; ketones, such as acetone and 2-butanone; alcohols, such as t-butyl alcohol and t-amyl alcohol; esters, such as ethyl acetate, propylene glycol monomethyl ether acetate, and γ-butyrolactone; nitriles, such as acetonitrile; amides, such as N, N-dimethylformamide and N, N-dimethylacetamide; halogenated hydrocarbons, such as o-dichlorobenzene, methylene chloride, and 1,2-dichloroethane; etc. One kind of solvent may be used, or two or more kinds may be used in mixture.

As the acid catalyst to be used in the reaction, various inorganic acids or organic acids can be used, and specific examples include acid catalysts such as hydrochloric acid, nitric acid, sulfuric acid, formic acid, oxalic acid, acetic acid, methanesulfonic acid, camphorsulfonic acid, tosylic acid, trifluoromethanesulfonic acid, anion-exchange resin, sodium hydrogen sulfate, and pyridinium p-toluenesulfonate. The amount of these acid catalysts used is preferably 1×10⁻⁵ to 5×10⁻¹ mol based on a total of 1 mol of the starting materials.

The reaction temperature is preferably −20° C. to 100° C., more preferably 0° ° C. to 80° C. When a solvent is used, the upper limit is preferably about the boiling point of the solvent. When the reaction temperature is −20° C. or higher, the reaction progresses smoothly, and when 100° C. or lower, it is possible to suppress side reactions such as a decomposition reaction of the product. The reaction time of the above-described reaction is preferably determined by monitoring the progress of the reaction by thin-layer chromatography, liquid chromatography, gel filtration chromatography, or the like to improve the yield, but the reaction time is usually around 0.5 to 200 hours. After completion of the reaction, the decomposable polymer (1a), which is the target product, can be obtained by a typical aqueous post-treatment (aqueous work-up) and/or filtration treatment of insoluble matter.

The obtained decomposable polymer (1a) can be, if necessary, purified by a conventional method, such as liquid-liquid separation, crystallization, concentration under reduced pressure, dialysis, and ultrafiltration, depending on the properties of the polymer. Furthermore, if necessary, the metal content can be reduced by passing the polymer through a commercially available demetallization filter.

As a method for the reaction, it is possible to employ, for example, a method in which respective starting materials, an acid catalyst, and if necessary, a solvent, are charged at once, a method in which respective starting materials or a starting material solution is/are added dropwise solely or as a mixture in the presence of a catalyst, or a method in which mixed starting materials or a solution of mixed starting materials is/are passed through a column or the like filled with a solid acid catalyst. With regard to adjustment of the molecular weight, it may be carried out, for example, by controlling a reaction time, by controlling an amount of the acid catalyst, by controlling an added/contained ratio of a polymerization terminator, such as water, an alcohol, a basic compound, etc., and when two kinds of the starting materials are used, by controlling a ratio of the charged starting materials, or by controlling a plurality of the above in combination.

One kind of the starting material compounds represented by the general formulae (5) to (8) may be used, or two or more kinds of each compound may be used in combination. The compounds, such as the starting material compounds represented by the general formulae (5), (7) and (8), are unstable to oxygen, light, moisture, etc., in some cases, and in such a case, the reaction is preferably carried out under an inert gas atmosphere, such as nitrogen, and under shielding light.

The decomposable polymers (1b) and (1c) can be produced specifically, for example, by a method selected from the following two methods. By a similar method, the decomposable polymer (1) can also be produced. It should be noted that the methods for producing the decomposable polymers used in the present invention are not limited thereto.

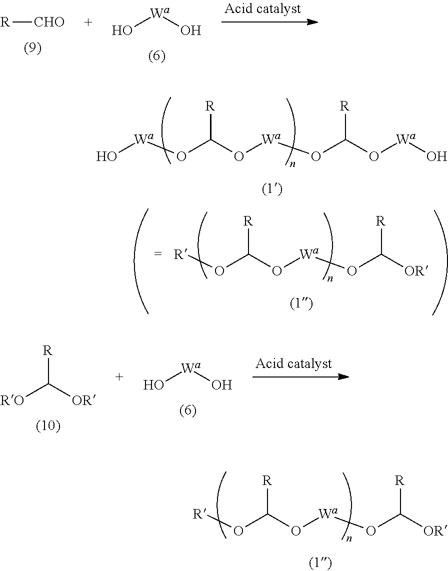

In the formulae, R represents R^{1a} or R^{1c}. R′ represents R^{b1} or R^{c1}. W^{a} represents a saturated or unsaturated divalent hydrocarbon group having 4 to 10 carbon atoms and optionally having an ether bond. Each R^{b1} independently represents —W^{a}—OH or a saturated or unsaturated monovalent organic group having 1 to 30 carbon atoms, the organic group optionally being substituted. R^{1c} represents a hydrogen atom, an aryl group having 6 to 20 carbon atoms, or a heteroaryl group having 4 to 20 carbon atoms, the aryl group or the heteroaryl group optionally being substituted. Each R^{c1} independently represents an alkyl group having 1 to 4 carbon atoms or —W^{a}—OH. “n” represents an average repeating unit number of 3 to 2,000.

The above-described reaction is, as an elementary reaction, a common acetal formation reaction using an acid catalyst. A polymer can be finally obtained by this elementary reaction proceeding repeatedly. In the above-described reaction, an optimum amount of the diol compound (6) to be used relative to the aldehyde compound (9) is preferably 0.5 mol to 2 mol, in particular 0.8 mol to 1.2 mol, of the (6) relative to 1 mol of the (9). In the above-described reaction, an optimum amount of the diol compound (6) to be used relative to the acetal compound (10) is preferably 0.5 mol to 2 mol, in particular 0.8 mol to 1.2 mol, of the (6) relative to 1 mol of the (10).

The acetalization reaction can be carried out by mixing the respective starting materials with an acid catalyst in a solvent or without the solvent, and cooling or heating the mixture. When a solvent is to be used in the reaction, the solvent can be selected from aliphatic hydrocarbons, such as hexane and heptane; aromatic hydrocarbons, such as toluene, xylene, trimethylbenzene, and methylnaphthalene; ethers, such as diethyl ether, dibutyl ether, diethylene glycol diethyl ether, diethylene glycol dimethyl ether, and tetrahydrofuran; ketones, such as acetone and 2-butanone; alcohols, such as t-butyl alcohol and t-amyl alcohol; esters, such as ethyl acetate, propylene glycol monomethyl ether acetate, and γ-butyrolactone; nitriles, such as acetonitrile; amides, such as N, N-dimethylformamide and N, N-dimethylacetamide; halogenated hydrocarbons, such as o-dichlorobenzene, methylene chloride, and 1,2-dichloroethane; etc. One kind of solvent may be used, or two or more kinds may be used in mixture.

As the acid catalyst to be used in the reaction, various inorganic acids or organic acids can be used, and specific examples include acid catalysts such as hydrochloric acid, nitric acid, sulfuric acid, formic acid, oxalic acid, acetic acid, methanesulfonic acid, camphorsulfonic acid, tosylic acid, trifluoromethanesulfonic acid, anion-exchange resin, sodium hydrogen sulfate, and pyridinium p-toluenesulfonate. The amount of these acid catalysts used is preferably 1×10⁻⁵ to 5×10⁻¹ mol based on a total of 1 mol of the starting materials.

The reaction temperature is preferably 0° ° C. to 250° ° C., more preferably 20° ° C. to 200° C. When the solvent is used, the boiling point or so of the solvent is preferably set to the upper limit. When the reaction temperature is 0° C. or higher, the reaction proceeds smoothly, while when it is 250° C. or lower, side reactions such as decomposition reaction of the product etc. can be suppressed. The reaction time of the above-described reaction is preferably determined by tracing the progress of the reaction by thin layer chromatography, liquid chromatography, gel filtration chromatography, etc., to improve the yield, and is generally 0.5 to 200 hours or so. After completion of the reaction, the decomposable polymer (1″), i.e., the decomposable polymer (1b) or (1c) which is the objective product, can be obtained by an ordinary aqueous system post treatment (aqueous work-up) and/or the filtration treatment of the insoluble components.

The obtained decomposable polymer (1″) may be purified, if necessary, by a conventional method such as liquid-liquid separation, crystallization, concentration under reduced pressure, dialysis, ultrafiltration, etc., depending on the characteristics thereof. In addition, if necessary, the product may be passed through a commercially available demetallization filter to reduce the metal content therein.

As a method for the reaction, it is possible to employ, for example, a method in which respective starting materials, an acid catalyst, and a solvent, if necessary, are charged at once, a method in which respective starting materials or a starting material solution is/are added dropwise solely or as a mixture in the presence of a catalyst, or a method in which mixed starting materials or a mixed starting material solution is/are passed through a column or the like filled with a solid acid catalyst. The reaction is preferably carried out while distilling off water or an alcohol produced by the reaction, since the reaction rate can be improved in this manner. With regard to adjustment of the molecular weight, it may be carried out, for example, by controlling a reaction time, by controlling an amount of the acid catalyst, by controlling an added/contained ratio of a polymerization terminator, such as water, an alcohol, a basic compound, etc., by controlling a ratio of the charged starting materials, or by controlling the above in optional combination.

The resin (B) is preferably contained in the conductive material composition in such an amount that the amount of metal nanowires (A) relative to 100 parts by mass of the resin (B) is 5 to 1000 parts by mass.

### [(C) Solvent]

The inventive conductive material composition also contains a solvent as a component (C). Specific examples of the solvent (C) include water, heavy water, alcohols, such as methanol, ethanol, propanol, and butanol; polyvalent aliphatic alcohols, such as ethylene glycol, propylene glycol, 1,3-propanediol, dipropylene glycol, 1,3-butylene glycol, 1,4-butylene glycol, D-glucose, D-glucitol, isoprene glycol, 1,2-butanediol, 1,3-butanediol, 1,4-butanediol, 2,3-butanediol, 1,2-pentanediol, 1,5-pentanediol, 1,2-hexanediol, 1,6-hexanediol, 1,9-nonanediol, and neopentyl glycol; linear ethers, such as dialkyl ether, ethylene glycol monoalkyl ether, ethylene glycol dialkyl ether, propylene glycol monoalkyl ether, propylene glycol dialkyl ether, polyethylene glycol dialkyl ether, and polypropylene glycol dialkyl ether; cyclic ether compounds, such as dioxane and tetrahydrofuran; polar solvents, such as cyclohexanone, methyl amyl ketone, ethyl acetate, butanediol monomethyl ether, propylene glycol monomethyl ether, ethylene glycol monomethyl ether, butanediol monoethyl ether, propylene glycol monoethyl ether, ethylene glycol monoethyl ether, propylene glycol dimethyl ether, diethylene glycol dimethyl ether, propylene glycol monomethyl ether acetate, propylene glycol monoethyl ether acetate, ethyl pyruvate, butyl acetate, methyl 3-methoxypropionate, ethyl 3-ethoxypropionate, tert-butyl acetate, t-butyl propionate, propylene glycol mono-t-butyl ether acetate, γ-butyrolactone, N-methyl-2-pyrrolidone, N, N′-dimethylformamide, N, N′-dimethylacetamide, dimethyl-sulfoxide, and hexamethylene phosphoric triamide; carbonate compounds, such as ethylene carbonate and propylene carbonate; heterocyclic compounds, such as 3-methyl-2-oxazolidinone; nitrile compounds, such as acetonitrile, glutaronitrile, methoxyacetonitrile, propionitrile, and benzonitrile; mixtures thereof, etc. However, the solvent is not limited to these examples.

The solvent is preferably contained in an amount of 10 to 50,000 parts by mass based on 100 parts by mass of the resin (B).

### [Other Components]

The inventive conductive material composition can also contain components besides the above-described components (A) to (C). In the following, the components other than the components (A) to (C) are described in detail.

### (Surfactant)

In the present invention, a surfactant may be contained to increase wettability of the conductive material composition to a workpiece, such as a substrate. Examples of such a surfactant include various surfactants such as nonionic, cationic, and anionic surfactants. Specific examples thereof include nonionic surfactants, such as polyoxyethylene alkyl ether, polyoxyethylene alkylphenyl ether, polyoxyethylene carboxylic acid ester, sorbitan ester, and polyoxyethylene sorbitan ester; cationic surfactants, such as alkyltrimethyl ammonium chloride and alkylbenzyl ammonium chloride; anionic surfactants, such as alkyl or alkylallyl sulfates, alkyl or alkylallyl sulfonate, and dialkyl sulfosuccinate; amphoteric ionic surfactants, such as amino acid type and betaine type; etc.

When a surfactant is to be contained, the amount thereof to be contained is preferably 5 to 1000 parts by mass based on 100 parts by mass of the resin (B).

### (Acid Generator)

A resin (B) whose main chain can be decomposed by an acid, heat, or both is capable of undergoing main-chain decomposition at a low temperature because of the presence of an acid. An acid may be contained in the composition, but it is preferable for the composition not to contain an acid, since this suppresses the decomposition of the component (B) resin progressing during storage of the composition. It is preferable for the composition to contain, instead, a neutral acid generator that generates an acid due to light or heat and becomes acidic, that is, a photo-acid generator or a thermal acid generator.

Examples of acid generators include neutralized salts, such as ammonium salts, pyridinium salts, sulfonium salts, iodonium salts, phosphonium salts, and diazonium salts of acids; sulfonyldiazomethane; N-sulfonyloxyimide; oxime-O-sulfonate; etc. Specific examples of acid generators are disclosed, for example, in paragraphs to of JP2008-111103A. One kind of these acid generators may be used, or two or more kinds thereof may be used in mixture.

When an acid generator is to be contained, the amount to be contained is preferably 0.1 to 50 parts by mass based on 100 parts by mass of the resin (B).

The inventive conductive material composition as described above can be formed into a film by a method such as spin coating, roll coating, flow coating, dip coating, spray coating, and doctor coating. Furthermore, patterning can also be performed by a method such as screen printing, gravure printing, flexographic printing, and inkjet printing.

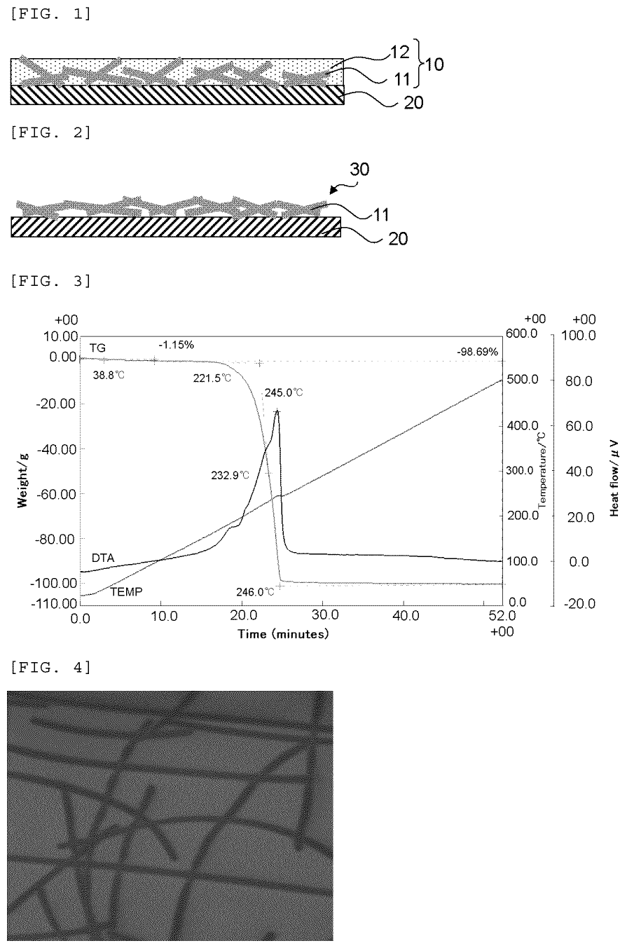

FIG. 1 shows schematically a cross-sectional view of a coating film obtained by applying an example of the inventive conductive material composition onto a substrate.

The coating film 10 of the conductive material composition is applied onto (coats) the substrate 20. The coating film 10 of the conductive material composition includes metal nanowires (A) 11, a resin (B) 12, and a solvent, which is not shown. The resin (B) 12 is a resin whose main chain is to be decomposed by an acid, heat, or both. By allowing an acid, heat, or both to act on the resin (B) 12 in the coating film 10 of such a conductive material composition, the resin (B) 12 can be decomposed, and the resin (B) 12 can be removed from the coating film 10.

In this manner, as explained above, a uniform layer of the metal nanowires (A) 11 can be formed by virtue of the presence of the resin (B) 12 at the time of the application of the composition, and a high-transparency and high-conductivity conductive film 30 of the metal nanowires (A) 11, shown in FIG. 2, can be formed by the insulating resin (B) 12 being decomposed and evaporating due to an acid and/or heat.

### <Conductive Film>

The conductive film 30 shown in FIG. 2 is an example of the inventive conductive film. That is, the inventive conductive film 30 is the conductive film 30 formed on the substrate 20. The conductive film 30 is, for example, a coating of the inventive conductive material composition on the substrate 20, as shown in FIG. 1, the resin (B) component of the composition having been decomposed and/or removed by an acid, heat, or both.

### <Method for Manufacturing Conductive Film>

The present invention also provides a method for forming a conductive film, including:
coating a substrate with the inventive conductive material composition; and
decomposing and/or removing the resin (B) component by an acid, heat, or both to form a conductive film.

In this method, for example, the inventive conductive material composition is applied onto a substrate, and then the resin (B) is decomposed and evaporated by heat and/or an acid. Thus, a conductive film of silver nanowires can be formed.

The heating may be, for example, heating with a hot plate or an oven or irradiation with infrared rays, near infrared rays, visible light, ultraviolet light, microwaves, or electromagnetic waves. The irradiation may be by continuous waves or momentary flash waves.

When the thermal decomposition temperature of the resin (B) is 200 to 300° C. and the resin (B) is to be decomposed by heating, heating in this range is necessary. When the substrate has high heat resistance, such as glass, quartz, silicon, or polyimide, heating on a hot plate or in an oven at 200 to 300° C. is possible. In the case of an elastic substrate, such as polyurethane, the substrate has low heat resistance, and therefore, by using a flash annealing method to selectively heat only the metal nanowires, thermal deformation of the substrate can be suppressed.

When an acid generator described above is contained in the conductive material composition, the decomposition temperature of the resin (B) is decreased due to the acid generated by the decomposition of the acid generator. For example, when the composition contains an acid generator that generates trifluoromethanesulfonic acid, the thermal decomposition temperature can be lowered to 100° C. or lower.

For the conductive film to have properties of flexibility and elasticity, it is preferable for the metal nanowires to be fused to each other. To fuse the metal nanowires together, heating at about 250° ° C. is necessary.

### EXAMPLES

Hereinafter, the present invention will be specifically described with reference to Examples and Comparative Examples, but the present invention is not limited thereto.

As a silver nanowire solution 1 to be contained in each conductive material solution of the Examples and Comparative Examples, an aqueous solution containing silver nanowires having an average diameter of 20 nm and an average length of 10 μm at a concentration of 5 mg/mL, available from Sigma-Aldrich Co., LLC., was used. As a silver nanowire solution 2, an aqueous solution containing silver nanowires having an average diameter of 60 nm and an average length of 40 μm at a concentration of 5 mg/mL, available from Sigma-Aldrich Co., LLC., was used.

It should be noted that the average diameter and average length of the silver nanowires are catalogue values of Sigma-Aldrich Co., LLC.

Meanwhile, the polymers (decomposable polymers) B1 to B3 shown below were synthesized by a synthesis method disclosed in JP2015-149384A. The structural formula and the molecular weight of the resins B1 to B3 are shown below. The resins B1 to B3 were each used as a solution of 20 mass % of the respective resin in isopropyl alcohol.

Incidentally, the Mw and Mw/Mn of each resin was determined by GPC (eluent: THE, standard: polystyrene). The average repeating unit number “n” was determined from the Mw.

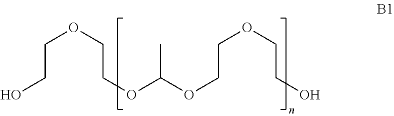

B1: Mw=5,200, Mw/Mn=2.64, n=34

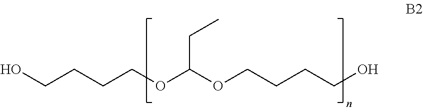

B2: Mw=3,900, Mw/Mn=2.34, n=26

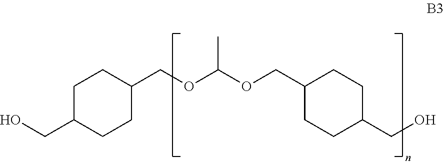

B3: Mw-6,400, Mw/Mn=2.53, n=20

FIG. 3 shows thermal decomposition data (DTA) of the resin B1 in air. It was observed from the thermal decomposition data shown in FIG. 3 that the decomposition start temperature of the resin B1 was 221.5° C. and that the decomposition end temperature thereof was 246° C.

In each Example and each Comparative Example, one of the resins B1 to B3, a solvent, a surfactant, and an additive were added to the silver nanowire solution 1 or 2 to prepare the conductive material solution of each Example and the composition of each Comparative Example shown in Table 1.

The surfactant and additives shown in Table 1 are as follows.

Fluoroalkyl-based nonionic surfactant FS-31 (available from DuPont)
Acid generator 1: triphenylsulfonium chloride
Acid generator 2: triphenylsulfonium methane sulfonic acid
Acid generator 3: triethylammonium trifluoromethane sulfonic acid
Acid generator 4: 4-fluoropyridinium trifluoromethane sulfonic acid

In Comparative Example 2, the following was used as a resin.

Polyvinylpyrrolidone: PVP, Mw=3.2, Mw/Mn=2.20

TABLE 1

| | | Resin | | | | Baking | Surface |
|---|---|---|---|---|---|---|---|
| | Silver nanowire dispersion | (parts | Additive | Solvent (parts | Irradiation | temperature | resistivity |
| Example | solution (parts by mass) | by mass) | (parts by mass) | by mass) | with light | (° C.) | (μΩcm) |
| Example 1 | Silver nanowire solution 1 (10) | B1 (10) | — | Water (100) | — | 250 | 52 |
| Example 2 | Silver nanowire solution 2 (10) | B1 (10) | — | Water (50) | — | 250 | 21 |
| Example 3 | Silver nanowire solution 2 (10) | B1 (10) | FS-31 (0.05) | Water (50) | — | 250 | 33 |
| Example 4 | Silver nanowire solution 2 (10) | B2 (10) | Acid generator 1 (0.1) | Water (50) | Performed | 100 | 26 |
| Example 5 | Silver nanowire solution 2 (10) | B3 (10) | Acid generator 2 (0.1) | Water (50) | Performed | 100 | 25 |
| Example 6 | Silver nanowire solution 2 (10) | B2 (10) | Acid generator 3 (0.1) | Water (50) | Performed | 180 | 32 |
| Example 7 | Silver nanowire solution 2 (10) | B3 (10) | Acid generator 4 (0.1) | Water (50) | Performed | 150 | 20 |
| Comparative Example 1 | Silver nanowire solution 1 (10) | — | — | Water (100) | — | 250 | 2 × 10⁸ |
| Comparative Example 2 | Silver nanowire solution 1 (10) | PVP (2.0) | — | Water (100) | — | 250 | 5 × 10³ |

Each of the conductive material compositions of the Examples and the compositions of the Comparative Examples shown in Table 1 was respectively applied onto a synthetic quartz wafer, baked on a hot plate at the temperature shown above in Table 1 to remove the resin in the composition by decomposition and evaporation. Thus, a conductive film of each example was obtained. In Examples 4 and 5, irradiation with light was performed for 60 seconds before the baking, by using a low-pressure mercury lamp having an irradiation power of 10 mW/cm².

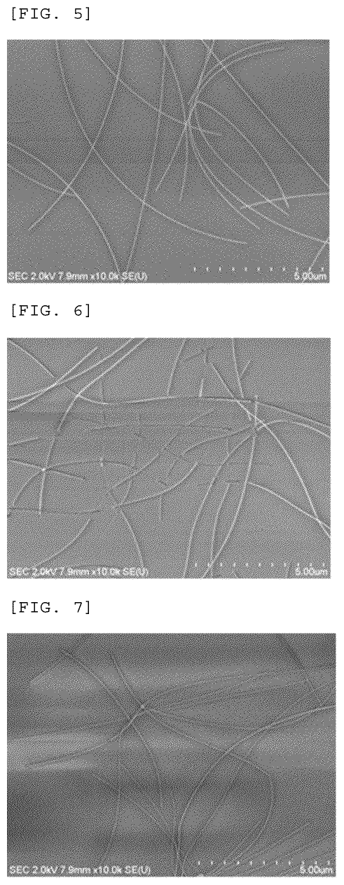

The surface resistivity of the conductive film after baking was measured, and observation with a scanning electron microscope (SEM) was performed, as shown in FIGS. 4 to 7.

FIG. 4 is a scanning electron microscope (SEM) photograph, observed at a magnification of 10,000×, of a surface of the film obtained by applying the conductive material composition of Example 1 onto a quartz wafer and baking the composition on a hot plate at 220° C. for 10 minutes. As indicated by the DTA data in FIG. 3, the resin B1 is not decomposed at this temperature, and remains black.

FIG. 5 is a scanning electron microscope (SEM) photograph, observed at a magnification of 10,000×, of a surface of the film obtained by applying the conductive material composition of Example 1 onto a quartz wafer and baking the composition on a hot plate at 250° C. for 10 minutes. As indicated by the DTA data in FIG. 3, the resin B1 is decomposed and eliminated at this temperature, and white silver nanowires have appeared.

FIG. 6 is a scanning electron microscope (SEM) photograph, observed at a magnification of 10,000×, of a surface of the film obtained by applying the conductive material composition of Comparative Example 1 onto a quartz wafer and baking the composition on a hot plate at 250° C. for 10 minutes. In this photograph, the silver nanowires are broken.

FIG. 7 is a scanning electron microscope (SEM) photograph, observed at a magnification of 10,000×, of a surface of the film obtained by applying the conductive material composition of Comparative Example 2 onto a quartz wafer and baking composition on a hot plate at 250° ° C. for 10 minutes. In this photograph, the base resin remains black.

It was shown from Table 1 that in the cases where the substrate was coated with a silver nanowire dispersion according to the present invention containing a heat- or acid-decomposable polymer, a conductive film having high conductivity was formed by decomposing and removing the resin B1 by heating, as shown in FIG. 5 of Example 1. Similarly, in Examples 2 to 7, a conductive film having high conductivity was successfully formed. Furthermore, the conductive films of Examples 1 to 7 were uniform, and exhibited high transparency.

On the other hand, in Comparative Example 1, where a silver nanowire dispersion containing no heat- or acid-decomposable polymers was used, the silver nanowires had been broken during heating as shown in FIG. 6, and conductivity was low. Meanwhile, in the case of the silver nanowire dispersion composition containing conventional polyvinylpyrrolidone, which cannot be decomposed by heat or an acid, the silver nanowires were not broken after the heating but polyvinylpyrrolidone remained, as shown in FIG. 7 of Comparative Example 2, and conductivity was low.

The present description includes the following embodiments.
[1] A conductive material composition comprising:
(A) metal nanowires;
(B) a resin whose main chain is to be decomposed by an acid, heat, or both; and
(C) a solvent.
[2] The conductive material composition of the above [1], wherein the resin (B) comprises a repeating unit having an acetal structure represented by the following general formula (1),

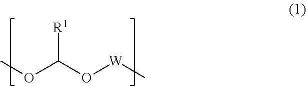

wherein R¹ represents a hydrogen atom or a saturated or unsaturated monovalent organic group having 1 to 30 carbon atoms, the organic group being optionally substituted; and W represents a saturated or unsaturated divalent organic group having 2 to 30 carbon atoms.
[3] The conductive material composition of the above [1] or [2], wherein the resin (B) is a compound represented by one of the following general formulae (1a) to (1c),

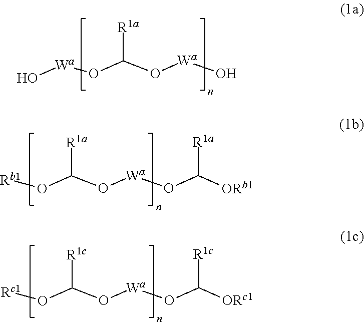

wherein R^{1a} represents an alkyl group having 1 to 4 carbon atoms; W^{a} represents a saturated or unsaturated divalent hydrocarbon group having 4 to 10 carbon atoms and optionally has an ether bond; each R^{b1} independently represents —W^{a}—OH or a saturated or unsaturated monovalent organic group having 1 to 30 carbon atoms, the organic group being optionally substituted; R^{1c} represents a hydrogen atom, an aryl group having 6 to 20 carbon atoms, or a heteroaryl group having 4 to 20 carbon atoms, the aryl group or the heteroaryl group being optionally substituted; each R^{c1} independently represents an alkyl group having 1 to 4 carbon atoms or —W^{a}—OH; and “n” represents an average repeating unit number of 3 to 2,000.
[4] The conductive material composition of any one of the above [1] to [3], further comprising a photo-acid generator or a thermal acid generator.
[5] A conductive film formed on a substrate, comprising
a coating of the conductive material composition according to any one of the above [1] to [4] on the substrate, wherein the resin (B) component has been decomposed and/or removed by an acid, heat, or both.
[6] A method for forming a conductive film, comprising:
coating a substrate with the conductive material composition according to any one of the above [1] to [4]; and
decomposing and/or removing the resin (B) component by an acid, heat, or both to form a conductive film.

It should be noted that the present invention is not limited to the above-described embodiments. The embodiments are just examples, and any examples that have substantially the same feature and demonstrate the same functions and effects as those in the technical concept disclosed in claims of the present invention are included in the technical scope of the present invention.

1. A conductive material composition comprising:
(A) metal nanowires;
(B) a resin whose main chain is to be decomposed by an acid, heat, or both; and
(C) a solvent.

2. The conductive material composition according to claim 1, wherein the resin (B) comprises a repeating unit having an acetal structure represented by the following general formula (1), 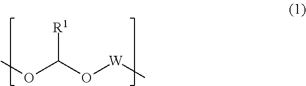
wherein R¹ represents a hydrogen atom or a saturated or unsaturated monovalent organic group having 1 to 30 carbon atoms, the organic group being optionally substituted; and W represents a saturated or unsaturated divalent organic group having 2 to 30 carbon atoms.

3. The conductive material composition according to claim 2, wherein the resin (B) is a compound represented by one of the following general formulae (1a) to (1c), 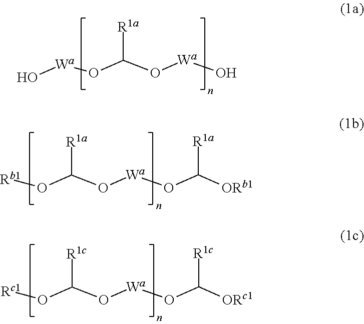
wherein R^{1a} represents an alkyl group having 1 to 4 carbon atoms; W^{a} represents a saturated or unsaturated divalent hydrocarbon group having 4 to 10 carbon atoms and optionally has an ether bond; each R^{b1} independently represents —W^{a}—OH or a saturated or unsaturated monovalent organic group having 1 to 30 carbon atoms, the organic group being optionally substituted; R^{1c} represents a hydrogen atom, an aryl group having 6 to 20 carbon atoms, or a heteroaryl group having 4 to 20 carbon atoms, the aryl group or the heteroaryl group being optionally substituted; each R^{c1} independently represents an alkyl group having 1 to 4 carbon atoms or —W^{a}—OH; and “n” represents an average repeating unit number of 3 to 2,000.

4. The conductive material composition according to claim 1, further comprising a photo-acid generator or a thermal acid generator.

5. A conductive film formed on a substrate, comprising
a coating of the conductive material composition according to claim 1 on the substrate, wherein the resin (B) component has been decomposed and/or removed by an acid, heat, or both.

6. A conductive film formed on a substrate, comprising
a coating of the conductive material composition according to claim 2 on the substrate, wherein the resin (B) component has been decomposed and/or removed by an acid, heat, or both.

7. A conductive film formed on a substrate, comprising
a coating of the conductive material composition according to claim 3 on the substrate, wherein the resin (B) component has been decomposed and/or removed by an acid, heat, or both.

8. A conductive film formed on a substrate, comprising
a coating of the conductive material composition according to claim 4 on the substrate, wherein the resin (B) component has been decomposed and/or removed by an acid, heat, or both.

9. A method for forming a conductive film, comprising:
coating a substrate with the conductive material composition according to claim 1; and
decomposing and/or removing the resin (B) component by an acid, heat, or both to form a conductive film.

10. A method for forming a conductive film, comprising:
coating a substrate with the conductive material composition according to claim 2; and
decomposing and/or removing the resin (B) component by an acid, heat, or both to form a conductive film.

11. A method for forming a conductive film, comprising:
coating a substrate with the conductive material composition according to claim 3; and
decomposing and/or removing the resin (B) component by an acid, heat, or both to form a conductive film.

12. A method for forming a conductive film, comprising:
coating a substrate with the conductive material composition according to claim 4; and
decomposing and/or removing the resin (B) component by an acid, heat, or both to form a conductive film.
